(19) United States
(12) Patent Application Publication
(10) Pub. No.: US 2013/0135485 A1
(43) Pub. Date: May 30, 2013

(54) ELECTRONIC APPARATUS

(71) Applicant: Sanyo Electric Co., Ltd., Moriguchi City (JP)

(72) Inventor: Seiya Shishido, Takatsuki City (JP)

(73) Assignee: Sanyo Electric Co., Ltd., Moriguchi City (JP)

(21) Appl. No.: 13/681,902

(22) Filed: Nov. 20, 2012

(30) Foreign Application Priority Data
Nov. 30, 2011 (JP) 2011-262200

(51) Int. Cl. H04N 5/228

(52) U.S. Cl. CPC H04N 5/228
USPC 348/207.99

(57) ABSTRACT

An electronic apparatus includes an internal recording medium. An internal recording medium records data. An abnormality detecting portion detects an abnormality of the electronic apparatus at a predetermined timing. A diagnosis portion diagnoses a state of the electronic apparatus. In a case where the abnormality is detected by the abnormality detecting portion, the diagnosis portion is caused to execute a diagnosis on the electronic apparatus, and a diagnosis result and data recorded in the internal recording medium are recorded in an external recording medium.

### CROSS REFERENCE OF RELATED APPLICATION

The disclosure of Japanese Patent Application No. 2011-262200, which was filed on Nov. 30, 2011, is incorporated herein by reference.

### BACKGROUND OF THE INVENTION

1. Field of the Invention

The present invention relates to an electronic apparatus, and more particularly, relates to an improvement in security of an electronic apparatus.

2. Description of the Related Art

Recently, there is a wide-spread use of an electronic apparatus such as a digital camera and an IC recorder. These electronic apparatuses are small in size and excel at mobility.

Therefore, there is a case, for example, where the electronic apparatus is impaired or a function provided in the electronic apparatus is damaged (hereinafter, referred to as “failure”) as a result of the electronic apparatus being hit by a certain object while being carried by a user or the electronic apparatus being accidentally dropped.

In such a case, a user requests a customer service, and the like, to repair the failed electronic apparatus. At the customer service, in order to repair the failed electronic apparatus, an operator breaks apart the electronic apparatus to analyze a cause of the failure, and based on the analytical result, the operator performs a repair operation.

According to one example of this type of camera, a self-diagnosis on the apparatus is executed in response to a repair mode being set, and the diagnosis result is displayed.

In the above-described camera, however, the self-diagnosis is executed as a result of the repair mode being set. That is, unless the repair mode is set manually by the user, the self-diagnosis is not to be performed.

Therefore, in spite of the apparatus failure, the user continues to use the apparatus without knowing the failure, and as a result, this may lead to an accident.

### SUMMARY OF THE INVENTION

An electronic apparatus according to the present invention comprises: an internal recording medium which records data; an abnormality detecting portion which detects an abnormality of the electronic apparatus at a predetermined timing; and a diagnosis portion which diagnoses a state of the electronic apparatus, wherein in a case where the abnormality is detected by the abnormality detecting portion, the diagnosis portion is caused to execute a diagnosis on the electronic apparatus, and a diagnosis result and data recorded in the internal recording medium are recorded in an external recording medium.

The above described characteristics and advantages of the present invention will become more apparent from the following detailed description of the embodiment when taken in conjunction with the accompanying drawings.

### BRIEF DESCRIPTION OF THE DRAWINGS

FIG. 1 is a block diagram showing an overview of a configuration of one embodiment of an imaging apparatus 1 according to the present invention;

FIG. 2 is an illustrative view showing one example of a mode where the imaging apparatus 1 according to the present invention executes a notification of an abnormal detection;

FIG. 3 is a flowchart showing a processing operation of an activating process of the imaging apparatus 1 according to the present invention;

FIG. 4 is a flowchart showing a processing operation during a data back-up execution of the imaging apparatus 1 according to the present invention;

FIG. 5 is a schematic diagram showing one example of a diagnosis item to be diagnosed during a self-diagnosis execution; and

FIG. 6 is a flowchart showing a processing operation when a self-diagnosis is executed on the imaging apparatus 1 according to the present invention.

### DETAILED DESCRIPTION OF THE PREFERRED EMBODIMENTS

A description is provided as an example where the present invention is applied to an imaging apparatus such as a digital camera and a digital video camera, as one embodiment of the present invention.

(Configuration of Imaging Apparatus 1)

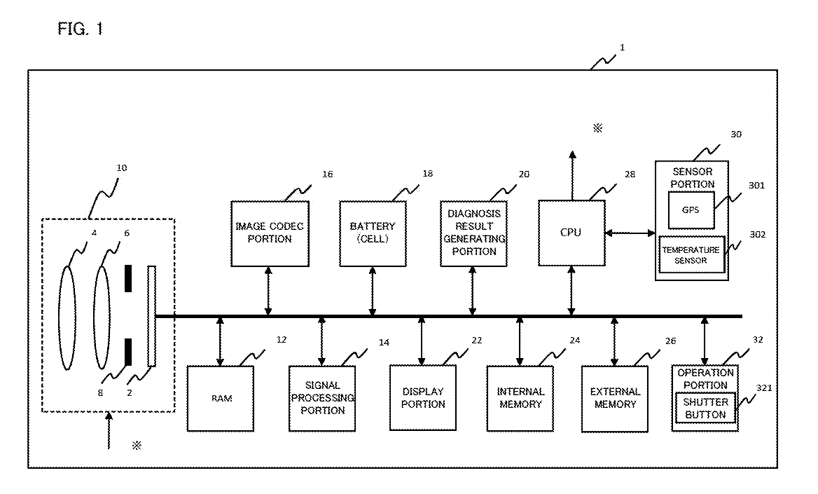

FIG. 1 is a block diagram showing an overview of a configuration of an imaging apparatus 1 according to the present invention. The imaging apparatus 1 is provided with an imaging element (image sensor) 2, a zoom lens 4 for changing a photographing field angle (zoom magnification) of a subject, a focus lens 6 for focusing on a subject, and an imaging portion 10 including an aperture 8, for example, for adjusting an exposure amount.

Furthermore, the imaging apparatus 1 is provided with a RAM (Random Access Memory) 12 which temporarily records an image (hereinafter, described as a “subject image”), etc., equivalent to the subject captured by the imaging portion 10, and a signal processing portion 14 which performs various types of signal processes, such as a color interpolation process, a white balance adjustment, and a noise reduction process, on the subject image temporarily recorded in the RAM 12.

Furthermore, the imaging apparatus 1 is provided with an image codec portion 16 which performs a compression coding process on the subject image according to a JPEG (Joint Photographic Experts Group) format when the subject image processed in the signal processing portion 14 is a still image and an MPEG (Moving Picture Experts Group) format when the same is a moving image, so as to generate a compressed image signal.

Moreover, the imaging apparatus 1 is provided with a battery 18 which supplies a power to each portion of the imaging apparatus 1 so as to operate each portion thereof, and a diagnosis result generating portion 20 which detects an operation abnormality of the imaging apparatus 1.

Furthermore, the imaging apparatus 1 is provided with a display portion 22 which displays the subject image, an internal memory 24 for recording the photographed subject image, and an external memory 26.

Moreover, the imaging apparatus 1 is provided with a CPU (Central Processing Unit) 28 which controls an operation of the imaging apparatus 1, a sensor portion 30 which detects a state of a main body of the imaging apparatus 1, and an operation portion 32 which accepts an operation performed by the user on the imaging apparatus 1 and applies a command according to the operation, to the CPU 28.

The imaging element 2 uses, for example, a solid-state imaging element such as a CCD (Charge Coupled Device) image sensor and a CMOS (Complementary Metal Oxide Semiconductor) image sensor.

The RAM 12 uses, for example, a generally used RAM such as a VRAM (Video Random Access Memory), an SRAM (Static Random Access Memory), a DRAM (Dynamic Random Access Memory), or an SDRAM (Synchronous DRAM).

The display portion 22 uses, for example, an LCD (Liquid Crystal Display) monitor and an organic EL (Electro-Luminescence) monitor. Furthermore, the display portion 22 may be of touch-panel system which senses a contact of a finger of a human.

The internal memory 24 uses an internal recording medium, such as a flash memory and an internal HDD (Hard Disk Drive), contained in the imaging apparatus 1.

The external memory 26 uses an external recording medium, such as an SD memory card, a memory stick (registered trademark), and an external HDD, detachable to and from the imaging apparatus 1.

The sensor portion 30 is provided, for example, with a GPS (Global Positioning System) 301 which measures a current location of the imaging apparatus 1, and a temperature sensor 302 which detects a temperature inside the main body of the imaging apparatus 1.

The operation portion 32 is provided, for example, with a shutter button 321 which causes a photographing process to be executed, a zoom switch (not shown) which drives the zoom lens 4 to adjust a zoom magnification of the subject, and a timer switch (not shown) which sets a self timer.

(Activating Process of Imaging Apparatus 1)

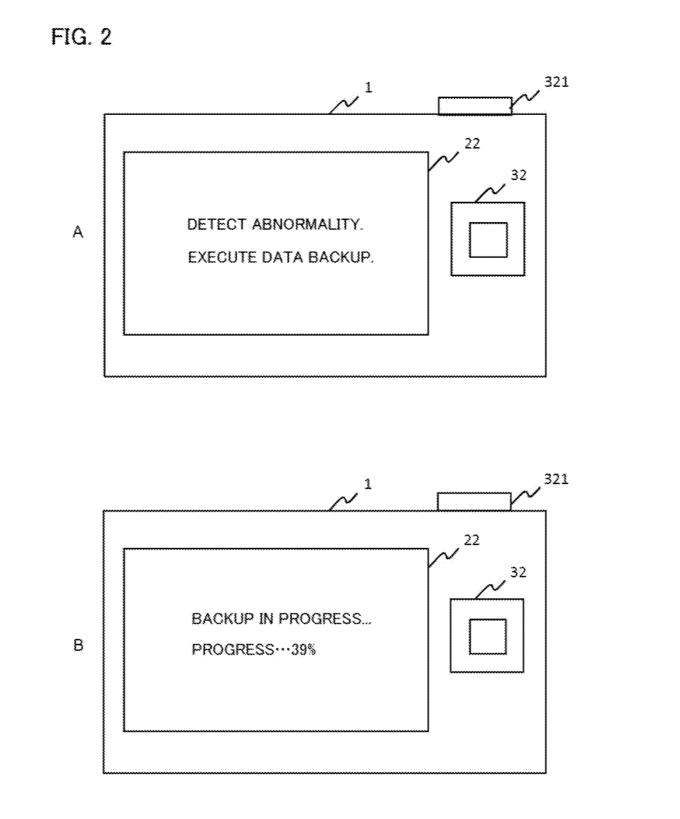

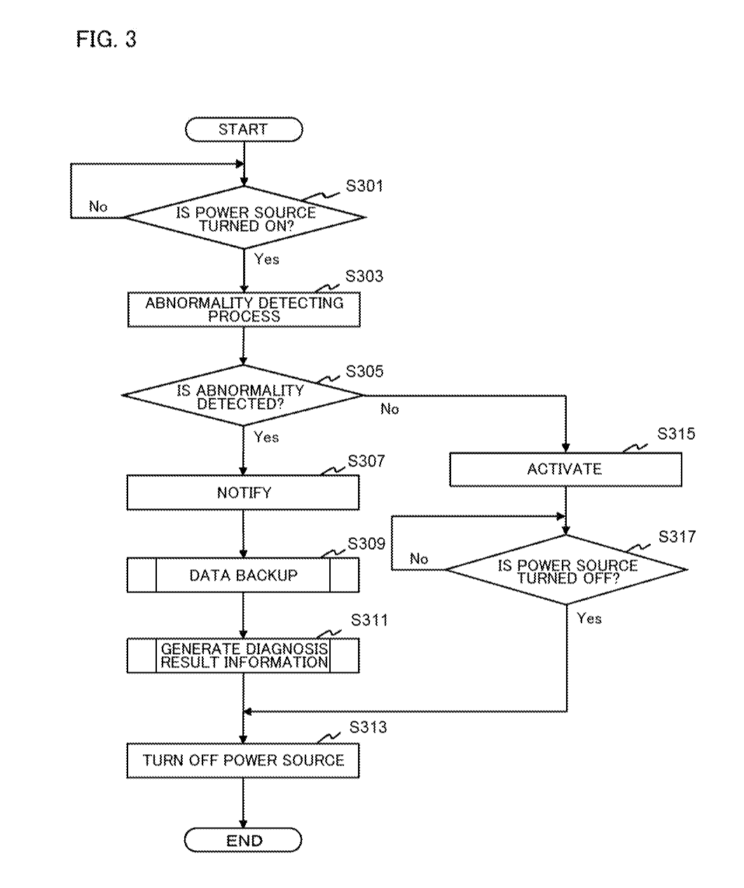

Subsequently, with reference to FIG. 2 and FIG. 3, an operation of the activating process of the imaging apparatus 1 is described.

When a power source of the imaging apparatus 1 is turned on, a power is supplied from the battery 18 to each portion of the imaging apparatus 1.

The CPU 28 causes the imaging portion 10 to perform a predetermined operation pattern, and determines, based on a signal outputted at that time, whether or not an abnormality occurs in each portion configuring the imaging portion 10. A method of detecting the abnormality is described later.

When it is determined by the CPU 28 that there does not occur the abnormality in each portion configuring the imaging portion 10, the imaging apparatus 1 is activated so as to move a current mode to an operation mode relating to photographing or reproducing the subject such as a still image photographing mode, a moving image photographing mode, and a reproducing mode.

Thereafter, the imaging apparatus 1 performs a processing operation according to each operation mode, in accordance with the operation by the user, until the imaging apparatus 1 is applied by the user a power-source off operation.

On the other hand, when it is determined by the CPU 28 that there occurs the abnormality in at least one region of each portion configuring the imaging portion 10, all data recorded in the internal camera 24 is backed up to the external memory 26.

This is because if the imaging apparatus 1 is sent to a repair, then it is not possible, during the repair, to view the data recorded in the internal memory 24 or depending on a content of the repair, the data recorded in the internal memory 24 may be erased.

When the backup is executed, the CPU 28 notifies the user by displaying on the display portion 22, as shown in FIG. 2A, to the effect that the backup is executed.

During the data backup, a process status of the backup may be displayed on the display portion 22, as shown in FIG. 2B. Furthermore, the power supply to a portion not requiring during the backup (for example, the signal processing portion 14) may be stopped.

Upon completion of the backup of the data, the CPU 28 instructs the diagnosis result generating portion 20 to execute the self-diagnosis on the imaging apparatus 1.

Upon reception of the instruction to execute the self-diagnosis from the CPU 28, the diagnosis result generating portion 20 collects state information of the imaging apparatus 1 when the abnormality is detected, creates the diagnosis result data, and records the same in the external memory 26. During the self-diagnosis, the display portion 22 may be caused to display that the self-diagnosis is in progress.

Upon completion of creating the diagnosis result data and recording into the external memory 26, the power source of the imaging apparatus 1 is automatically turned off. In this way, the user is capable of easily knowing the failure of the imaging apparatus 1.

FIG. 3 is a flowchart showing a processing operation relating to the activating process of the imaging apparatus 1. In a step S301, it is determined whether or not the power source of the imaging apparatus 1 is turned on.

When the power source is turned on, the process proceeds to a step S303, and otherwise, the step S301 is repeated.

In the step S303, an abnormality detecting process on each portion of the imaging portion 10 is executed. In a step S305, it is determined whether or not there occurs an abnormality in the imaging portion 10.

In a case where there occurs the abnormality in the imaging portion 10, the process proceeds to a step S307, and otherwise, the process proceeds to a step S315.

In the step S307, the user is notified that the abnormality is detected. In a step S309, the backup of the data is executed. Upon completion of the backup of the data, the process proceeds to a step S311.

In the step S311, the diagnosis result data of the imaging apparatus 1 is generated, and the generated diagnosis result data is written into the external memory 26. Upon completion of the writing of the diagnosis result data, the process proceeds to a step S313. In the step S313, the power source of the imaging apparatus 1 is turned off.

In the step S315, the imaging apparatus 1 is normally activated, and is set to a preview mode. In a step S317, it is determined whether or not a power-source turning off operation is performed by the user. When the power-source turning off operation is performed, the process proceeds to the step S313, and otherwise, the step S317 is repeated.

### (Processing Operation During Data Backup of Imaging Apparatus 1)

Subsequently, a processing operation of the imaging apparatus 1 when the data backup is executed is described. The CPU 28 calculates a size of the data recorded in the internal memory 24 (hereinafter, described as “backup data”).

Next, the CPU 28 refers to a vacant capacity of the external memory 26 so as to determine whether or not there is a vacant capacity allowing the backup data to be recorded.

At this time, it is desired to determine whether or not the vacant capacity of the external memory 26 is a capacity that exceeds by several Mbytes to several tens of Mbytes than the size of the backup data.

This is performed in order to ensure a region in which the diagnosis result data is recorded. In doing so, when the diagnosis result data is written into the external memory 26, it is not necessary any more to refer again to the vacant capacity of the external memory 26, and as a result, it is possible to shorten a processing time.

When it is determined that there is not the vacant capacity allowing the backup data to be recorded, the display portion 22 is caused to display the absence of the vacant capacity so that the user is prompted to attach another external memory.

When a new external memory 26 is attached, the vacant capacity of the external memory 26 is again referred to.

When it is determined that the external memory 26 has the vacant capacity allowing the backup data to be recorded, the backup data is written into the external memory 26.

Upon completion of writing the backup data into the external memory 26, the backup process is ended.

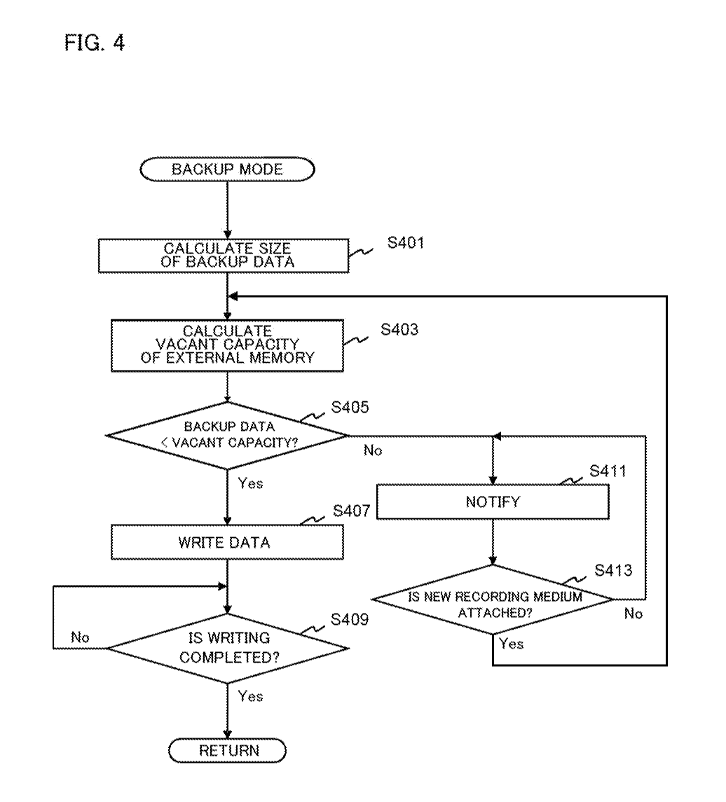

FIG. 4 is a flowchart showing a processing operation relating to the data backup in the step S305 in FIG. 3. The data backup process is executed according to a subroutine below.

In a step S401, the size of the backup data is calculated. In a step S403, the vacant capacity of the external memory 26 is calculated.

In a step S405, it is determined whether or not the vacant capacity of the external memory 26 exceeds the size of the backup data. In a case where the vacant capacity of the external memory 26 exceeds the size of the backup data, the process proceeds to a step S407, and otherwise, the process proceeds to a step S411.

In the step S407, the backup data is written into the external memory 26. In a step S409, it is determined whether or not the writing of the backup data is completed. In a case where the writing of the backup data is completed, the process returns to a routine at an upper hierarchical level, and otherwise, the step S409 is repeated.

In the step S411, it is notified that the vacant capacity of the external memory 26 is insufficient. In a step S413, it is determined whether or not a new external memory 26 has been attached to the imaging apparatus 1.

In a case where the new external memory 26 has been attached, the process returns to the step S403, and otherwise, the process returns to the step S411.

(Processing Operation when Self-Diagnosis is Executed on Imaging Apparatus 1)

Subsequently, the processing operation of the imaging apparatus 1 when the self-diagnosis is executed is described. The CPU 28 collects state information of the imaging apparatus 1 when the abnormality is detected so as to generate the diagnosis result data.

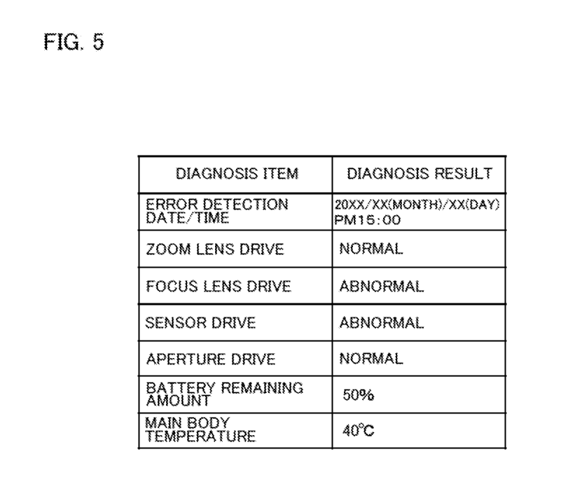

FIG. 5 is a schematic diagram showing a content of the diagnosis result data. The diagnosis result data is configured by a plurality of diagnosis items and diagnosis results of each diagnosis item.

Examples of the diagnosis items include a date and a time when an error is detected, a drive situation of each portion of the imaging portion 10, a drive situation of the aperture 8, a remaining amount of a battery, and a temperature of the main body.

To determine the drive situation of each portion of the imaging portion 10, the imaging portion 10 is caused to execute a predetermined operation pattern and a signal outputted at this time and an expected value recorded beforehand in the internal memory 24 are compared. In this way, whether or not each portion is normally driven is determined. An abnormality detecting process on the imaging portion 10 is described in detail later.

The CPU 28 collects information of each diagnosis item, and writes the same into the diagnosis result generating portion 20. Upon completion of the collection of the information of all the diagnosis items, the diagnosis result generating portion 20 creates a single data file in which each of the written diagnosis results is gathered (for example, a text file. Hereinafter, described as “diagnosis result data”), and writes the same into the external memory 26.

Upon completion of the writing of the diagnosis result data, the information of each diagnosis item written into the diagnosis result generating portion 20 is deleted, and the self-diagnosis is ended.

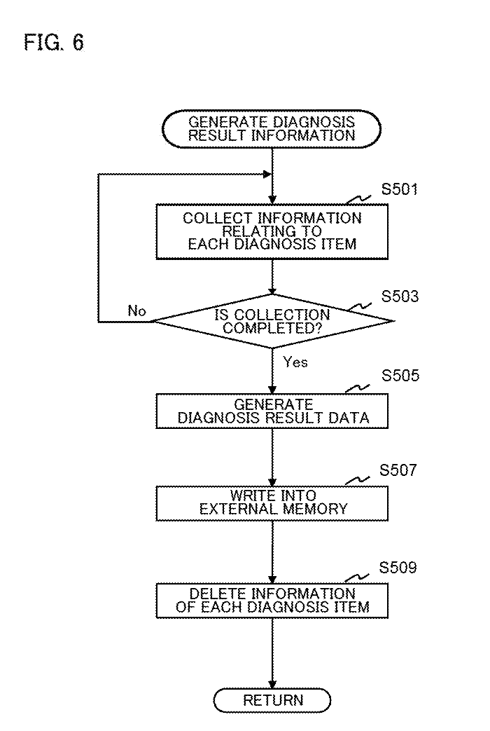

FIG. 6 is a flowchart showing a processing operation relating to the self-diagnosis in the step S307 in FIG. 3. The self-diagnosis is executed according to a subroutine below.

In a step S501, the information of the imaging apparatus 1 is collected according to each diagnosis item. In a step S503, it is determined whether or not the collection of the information is completed. In a case where the collection of the information of each diagnosis item is completed, the process proceeds to a step S505, and otherwise, the process returns to the step S501.

In the step S505, the diagnosis result data is generated from the collected information of the diagnosis items. In a step S507, the diagnosis result data generated in the step S505 is written into the external memory 26.

In a step S509, the information of each diagnosis item written into the diagnosis result generating portion 20 is deleted, and the process returns to the routine at an upper hierarchical level.

### (Abnormality Detection Processing Operation on Imaging Portion 10)

Subsequently, an abnormality detection processing operation on the imaging apparatus 1 is described. In order to perform an abnormality detection, the CPU 28 outputs an operation instruction with a predetermined pattern to each portion of the imaging portion 10.

Each portion of the imaging portion 10 performs an operation with a predetermined pattern according to the operation instruction outputted from the CPU 28, and sends back an outputted value during the operation, to the CPU 28.

The CPU 28 reads out an expected value recorded beforehand in the internal memory 24, and compares the outputted value outputted from each portion of the imaging portion 10 and the expected value read-out from the internal memory 24.

The expected value indicates an outputted value outputted from each portion of the imaging portion 10 when the operation with a predetermined pattern is normally performed, and the expected value corresponding to each portion of the imaging portion 10 is prepared, respectively.

As a result of the comparison, when the outputted value outputted from each portion of the imaging portion 10 is equal to the corresponding expected value, or a difference between the outputted value and the expected value is within a predetermined range, it is determined that the normal drive is in progress.

Specifically, the detection is performed as follows: Firstly, the abnormality detection on the imaging element 2 is described.

The CPU 28 outputs a command to bring the aperture 8 into a closed state, to the aperture 8. When the aperture 8 is set to the closed state, external light is shielded. At the same time, the CPU 28 drives the imaging element 2 for a predetermined time period (for example, ¼ seconds) so as to accumulate an electric charge.

In the imaging element 2, the electric charge from a defective pixel having many dark currents continues to accumulate in spite of the aperture 8 being in the closed state.

Upon completion of accumulation of the electric charge for ¼ seconds, the CPU 28 compares an amount of electric charges of each pixel of the imaging element 2 with a prescribed predetermined value, and counts the number of pixels that exceed the predetermined value.

In a case where, as a result of the count, the number of pixels having the amount of electric charges that exceeds the predetermined value is equal to or more than a predetermined number (for example, 100), it is determined that there occurs the abnormality in the imaging element 2.

Subsequently, the abnormality detection on the zoom lens 4 is described. The zoom lens 4 is driven by an actuator (not shown) arranged in the imaging apparatus 1.

The actuator is configured, for example, by a rotary gear connected to a motor and a cam framework meshed with the gear, and when the rotation of the motor is transmitted to the cam framework via the gear, it is possible to drive the zoom lens 4 along an optical axis direction.

Furthermore, the actuator is provided with an encoder which outputs a pulse signal at each rotation, by a predetermined amount, of the motor, and when the pulse signal is counted, it is possible to detect a rotation speed (in other words, the number of rotations per unit time) of the motor.

The CPU 28 outputs a command to cause the motor which drives the zoom lens 4 to rotate by a predetermined rotation speed (hereinafter, described as “instructed rotation speed).

The motor is rotated according to the instructed rotation speed. The encoder outputs a pulse signal generated by the rotation of the motor, to the CPU 28. The CPU 28 counts the pulse signals generated during a predetermined time period to detect an actual rotation speed.

The CPU 28 calculates a difference between the instructed rotation speed and the actual rotation speed, and determines whether the difference is within a prescribed threshold value TH.

As a result of the determination, when the error is within the threshold value TH, it is determined that the zoom lens 4 is normally driven, and when the error is outside the threshold value TH, it is determined that there occurs the abnormality in the drive of the zoom lens 4.

In this way, it is possible to detect a drive situation of the zoom lens 4. Furthermore, a similar method may be employed to detect a drive situation of the focus lens 6.

It is noted that rather than calculating the difference between the instructed rotation speed and the actual rotation speed, a ratio of the instructed rotation speed to the actual rotation speed may be used to perform the abnormality determination.

Subsequently, an abnormality detection on the aperture 8 is described. The CPU 28 outputs a command to bring the aperture 8 into an opened state. When the aperture 8 is set to the opened state, a photometry is executed. Then, a brightness at this time is detected, and a value indicating the brightness is stored in the RAM 12.

Next, the CPU 28 determines whether or not the detected brightness is equal to or more than a predetermined brightness. At this time, in a case where the detected brightness is below the predetermined brightness, it is determined that the abnormality occurs in the aperture 8.

In case where the detected brightness is equal to or more than the predetermined brightness, the CPU 28 outputs a command to bring the aperture 8 into a minimum aperture state.

When the aperture 8 is brought into the minimum aperture state, a photometry is executed, again. Then, the brightness at this time is detected, and a value indicating the brightness is stored in the RAM 12.

The CPU 28 calculates a difference between a value indicating the brightness in the opened state stored in the RAM 12 and a value indicating the brightness in the minimum aperture state, and determines whether or not the difference is within a range of a predetermined threshold value TH2.

As a result of the determination, when the difference is within the range of the threshold value TH2, it is determined that the aperture 8 is driven normally, and otherwise, it is determined that the abnormality occurs in the aperture 8.

It is noted that rather than calculating the difference between the value indicating the brightness in the opened state and the value indicating the brightness in the minimum aperture state, a ratio of the value indicating the brightness in the opened state to the value indicating the brightness in the minimum aperture state may be used to perform the abnormality determination.

### SUMMARY

In the above-described embodiment, when the power source of the imaging apparatus 1 is turned on, the abnormality detection on the imaging portion 10 is executed; however, for example, when the power source is turned off, too, the abnormality detection may be executed. Furthermore, during a time when the power source is turned on, the abnormality detection may be performed for each predetermined cycle.

In the above-described embodiment, the backup data and the diagnosis result data are recorded in the external memory 26 attached to the imaging apparatus 1.

However, a backup destination is not limited thereto, for example, in a case of an electronic apparatus capable of a data communication with an external server by way of a radio communication, the backup data and the diagnosis result data may be transmitted to the external server.

In the above-described embodiment, in a case where the abnormality is detected, the detection is displayed on the display portion 22 so that the user is notified thereof.

However, a method of notifying is not limited thereto, for example, in a case of an electronic apparatus provided with a speaker which outputs a sound, the sound may be outputted to notify the user.

Moreover, the imaging apparatus 1 in FIG. 1 may also be configured by hardware, or a combination of hardware and software.

In a case where the imaging apparatus 1 is configured by using the software, a block diagram about a region realized by the software is to show a functional block diagram of the region.

A function realized by the software is written as a program, and when the program is executed by a program executing device (for example, a computer), the function is realized.

Specifically, for example, when a program stored in a flash memory for storing a program, not shown in the block diagram in FIG. 1, is executed by the CPU 28, it is possible to realize each of the above-described functions.

In the block diagram in FIG. 1, for example, it is possible to configure the CPU 28, the imaging portion 10, the RAM 12, the battery 18, the display portion 22, the internal memory 24, the external memory 26, the sensor portion 30, and the operation portion 32, by hardware, and to configure other blocks by software.

However, it is possible to configure one part or all of the diagnosis result generating portion 20 and the operation portion 32, by hardware.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An electronic apparatus, comprising:
an internal recording medium which records data;
an abnormality detecting portion which detects an abnormality of the electronic apparatus at a predetermined timing; and
a diagnosis portion which diagnoses a state of the electronic apparatus, wherein in a case where the abnormality is detected by said abnormality detecting portion, said diagnosis portion is caused to execute a diagnosis on the electronic apparatus, and a diagnosis result and data recorded in said internal recording medium are recorded in an external recording medium.

2. An electronic apparatus according to claim 1, wherein the predetermined timing is when a power source of the electronic apparatus is one of turned on and turned off.

3. An electronic apparatus according to claim 1, further comprising a notifying portion which notifies the abnormality when the abnormality is detected by said abnormality detecting portion.

4. An electronic apparatus according to claim 3, wherein said notifying portion notifies by at least one of a sound output and a light emission.

5. An electronic apparatus according to claim 1, wherein the diagnosis result includes at least one of: information associated with a date and a time when the abnormality is detected; information associated with a temperature of the electronic apparatus; and information associated with a battery remaining amount.
